(19) United States
(12) Patent Application Publication
(10) Pub. No.: US 2024/0415114 A1
(43) Pub. Date: Dec. 19, 2024

(54) AGROCHEMICAL FORMULATIONS FOR MITIGATING CRYSTALLIZATION

(71) Applicant: SYNGENTA CROP PROTECTION AG, Basel (CH)

(72) Inventors: Nema Devi JHURRY, Greensboro, NC (US); James Owen FORREST, Greensboro, NC (US)

(73) Assignee: SYNGENTA CROP PROTECTION AG, Basel (CH)

(21) Appl. No.: 18/705,802

(22) PCT Filed: Oct. 24, 2022
(86) PCT No.: PCT/EP2022/079583

§ 371 Date: Apr. 29, 2024

(30) Foreign Application Priority Data
Oct. 29, 2021 (EP) 21205679.0

(51) Int. Cl. A01N 25/04; A01N 37/46; A01N 43/36; A01P 3/00

(52) U.S. Cl. CPC A01N 25/04; A01N 37/46; A01N 43/36; A01P 3/00

(57) ABSTRACT

Formulations having fludioxonil and castor oil.

The present invention relates to agrochemical compositions, and in particular compositions for treatment of a plant propagation material, and more specifically seed treatment compositions, and the preparation of such compositions and a method of using such compositions, for example, to combat pests.

### BACKGROUND OF THE INVENTION

In general, prior to planting, seeds can be treated with agrochemicals in order to control insect damage, fungal/microbial damage, etc which results after planting of the seeds. Formulations for treating seeds can include flow aids to facilitate application of the agrochemicals onto the seeds and planting of the seeds. However, flow aids and agrochemicals are not always compatible. For instance, a lack of compatibility between a flow aid and an agrochemical can result in the agrochemical crystalizing and dropping out of solution during storage rendering the formulation less or ineffective as a seed treatment. Crystallization of agrochemicals in formulations is problematic because crystals can cause application issues such as screen blockage, as well as, impacting efficacy of the agrochemical due to inhomogeneous distribution after application. Accordingly, there remains a need for new agrochemical formulations which address crystallization in agrochemical formulations.

### SUMMARY OF THE INVENTION

These and other problems are solved using castor oil in agrochemical formulations. The invention includes a composition having fludioxonil and castor oil.

### BRIEF DESCRIPTION OF THE DRAWINGS

FIG. 1 is a graphical representation of the solubility of fludioxonil in different oils.

FIG. 2A is a solubility curve of fludioxonil with mefenoxam and castor oil or soybean oil.

FIG. 2B is a solubility curve of fludioxonil with mefenoxam and castor oil or soybean oil.

FIG. 2C is a solubility curve of fludioxonil with mefenoxam and castor oil or soybean oil.

FIG. 3 shows the experimental results comparing crystallization of fludioxonil in castor oil, MK116 Wax, and soybean oil.

### DETAILED DESCRIPTION OF THE INVENTION

It has been discovered that fludioxonil has significantly improved solubility in castor oil which leads to fludioxonil crystallization mitigation/elimination in certain formulations. In particular, fludioxonil can maintain solubility in the formulations under a wide range of temperatures, for example, from 5° C. to 50° C. This prevents crystallization from occurring as the product is subjected to high temperatures followed by lower temperatures.

In certain embodiments, the formulations contain an organic phase. The organic phase can be, for example, a liquid agrochemical such as mefenoxam. In general, when an organic phase is present which negatively impacts fludioxonil loading, the amount of castor oil used can be in an amount greater or equal than the organic phase. For example, the amount of organic phase to castor oil can be for example in a ratio of at least 1:1, at least 1:1.5, at least 1:2, at least 1:2.5, at least 1:3, at least 1:4, at least 1:5, at least 1:10, at least 1:15, at least 1:20, etc. until there is no organic phase remaining in the formulation.

### Flow Aids

Flow aids are used in seed treatments to positively affect the flow of seeds in a planter. Generally, such products reduce the resistance for the flow of seeds. Poor seed flow can result in slow or inconsistent handling of seeds in equipment negatively impacting planting. As used herein, flow aids refer to oil based flow aids. Such flow aids can include oils such as silicone oil, mineral oil, vegetable oil, natural or plant oil, or any synthetic oil. In addition to comprising castor oil, compositions can include one or more additional flow aids.

Flow aids can be present in a range of 0.1 to 25% w/w. In the present invention, the expression “% w/w” means percentage by weight over the total weight of the composition. In preferred embodiments, flow aids can be present in a range of 2 to 15% by weight. As such, the flow aid can be present at, for example, 1%, 2%, 3%, 4%, 5%, 6%, 7%, 8%, 9%, 10, 1%, 12%, 13%, 14%, 15%, 16%, 17%, 18%, 19%, 20%, 21%, 22%, 23%, 24%, or 25% w/w, or any combination or value in-between.

### Agrochemicals

Agrochemicals include, but are not limited to selective herbicides, fungicides, other insecticides, bactericides, insect growth regulators, plant growth regulators, nematicides, molluscicides or mixtures of several of these preparations. In general, the amount of fungicide, insecticide or other ingredients used in the seed treatment are employed in amounts that do not inhibit germination of the seed or cause phytotoxic damage to the seed. The total amount of active ingredients is generally in the range of from about 0.5% to about 50% w/w, more specifically, from 2 to about 20% w/w. In specific embodiments, the active ingredients are from about 3 to about 10% w/w.

In some embodiments, fludioxonil is present in an amount of about 0.5 to 10% w/w. In other embodiments about 0.5 to 5% w/w. Fludioxonil can be present at, 0.5, 0.75, 1, 1.25, 1.5, 1.75, 2, 2.25, 2.5, 2.75, 3, 3.5, 4, 4.5, or 5% w/w for example, or any combination or value in-between.

Fungicides useful in the present compositions include any agent useful for the prevention or treatment of fungal pests. Such fungicides may be particularly useful in controlling certain phytopathogenic fungi, and provide high fungicidal activity and relatively low phytotoxicity.

More specifically, fungicides useful in the compositions can include, but are not limited to, diazole, triazole, phenylpyrrole, strobilurin, carboxamide, carboxanilide, especially ortho-substituted carboxanilide, carbamate, anilinopyrimidine, phenoxyquinoline, benzimidazole, systemic and phenylamide fungicides. More particularly, the present invention includes the use of systemic, strobilurin, and phenylpyrrole type fungicides. Even more particularly, the present invention includes the use of phenylpyrrole type fungicides.

Diazole fungicides that are useful include imidazoles and pyrazoles. Examples of diazole fungicides that are useful include, without limitation, imazalil, oxpoconazole, pefurazoate, prochloraz, and trifulmizole. Mixtures of such diazoles can also be used.

Examples of triazole fungicides that are preferred for use include, without limitation, amitrol, azaconazole, bitertanol, bromuconazole, climbazole, clotrimazole, cyproconazole, diclobutrazol, difenoconazole, diniconazole, diniconazole-M, epoxiconazole, etaconazole, fenbuconazole, fluquinconazole, fluotrimazole, flusilazole, flutriafol, furconazole, furconazole-cis, hexaconazole, imibenconazole, ipconazole, metconazole, myclobutanil, paclobutrazol, penconazole, propiconazole, quinconazole, simeconazole, tebuconazole, tetraconazole, triadimefon, triadimenol, triazbutil, triticonazole, and 1-(4-fluorophenyl)-2-(1H-1,2,4-triazole-1-yl)ethanone. Mixtures of such triazoles can also be used.

Examples of strobilurin-type fungicides that are useful include, without limitation, azoxystrobin, dimoxystrobin, famoxadone, fluoxastrobin, kresoxim-methyl, metominostrobin, picoxystrobin, pyraclostrobin, and trifloxystrobin. Mixtures of strobilurin type fungicides can also be used. Mixtures of strobilurin-type fungicidies can also be used.

Examples of phenylpyrrole type fungicides that are useful include, without limitation, fludioxonil and fenpiclonil. Mixtures of phenylpyrrole-type fungicidies can also be used.

Examples of amide and carboxamide type fungicides that are useful include, without limitation, boscalide, carboxin, fenfuram, flutolanil, furametpyr, mepronil, oxycarboxin, mandipropamid, and thifluzamide. Mixtures of amide and carboxamide-type fungicidies can also be used.

Examples of carboxanilide type fungicides include, especially, ortho-substituted carboxanilide type fungicides. Fungicides in this class include, without limitation, 3-difluoromethyl-1-methyl-1H-pyrazole-4-carboxylic acid (2-bicyclopropyl-2-yl-phenyl)-amide and the isomers thereof; and 3-difluoromethyl-1-methyl-1H-pyrazole-4-carboxylic acid [9-isopropyp-1,2,3,4-tetrahaydro-1,4-methano-naphthalen-5-yl]-amide, and the isomers thereof. Mixtures of carboxanilide-type fungicidies can also be used.

Examples of carbamate type fungicides that are useful in the present invention include, without limitation, propamacarb and propamacarb hydrochloride. Mixtures of carbamate-type fungicidies can also be used.

Examples of anilinopyrimidine type fungicides that are useful include, without limitation, cyprodnil, mepanipyrim and pyrimethanil. Mixtures of anilinopyrimidine-type fungicidies can also be used.

Examples of benzimidazole type fungicides that are useful include, without limitation, benomyl, carbendazim, fuberidazole, and thiabendazole. Mixtures of benzimidazole-type fungicidies can also be used.

Examples of systemic type fungicides that are useful in the present invention include, without limitation, mefenoxam, metalaxyl-M, thiophanate-methyl, benalaxyl, cymoxanil, cyprofuram, furalaxyl, ofurace, oxadixyl, fosetyl-aluminium, phosphorous acid and its salts. Mixtures of systemic-type fungicidies can also be used.

Mixtures of fungicides are also contemplated. For example, and not for limitation, mixtures of systemic type fungicides in combination with benzimidazole-, anilinopyrimidine-, carbamate-, carboxanilide-, amide- and carboxamide-, phenylpyrrole-, strobilurin-, or triazole-type fungicides are contemplated.

Preferred fungicides include fludioxonil, picarbutrazox, mefenoxam, sedaxane, and thiabendazole. More preferably, the composition of the present invention can comprise fludioxonil, mefenoxam, castor oil, and optionally at least one agrochemical, preferably at least two agrochemicals, and more preferably all the agrochemicals, selected from picarbutrazox, sedaxane, and thiabendazole.

Insecticides useful in the compositions include any agent useful for the prevention or treatment of damage caused by insect pests. Insecticides useful in the composition of the present invention include those classified as neonicotinoids, pyrethroids, phosphorus compounds, carbamates and others.

Examples of neonicotinoid insecticides that are useful include, without limitation, acetamiprid, clothianidin, dinotefuran, imidacloprid, nitenpyram, thiacloprid, thiamethoxam. Preferred neonicotinoid insecticides include clothianidil, imidacloprid and thiamethoxam. Mixtures of neonicotinoid insecticides are also contemplated. Particularly preferred neonicotinoid insecticides include thiamethoxam and imidacloprid.

Pyrethroid insecticides useful in the compositions include, without limitation, alpha-cypermethrin, beta-cyfluthrin, beta-cypermethrin, bifenthrin, bioallethrin, bioresmethrin, cycloprothrin, cyfluthrin, cyhalothrin, cypermethrin, cyphenothrin, deltamethrin, empenthrin, esfenvalerate, fenpropatluin, fenvalerate, flucythrinate, flumethrin, gamma-cyhalothrin, imiprothrin, lambda-cyhalothrin, methothrin, metofluthrin, permethrin, phenothrin, prallethrin, resmethrin, tau-fluvalinate, tefluthrin, tetramethrin, theta-cypennethrin, tralomethrin, transfluthrin, and zeta-cypermethrin. Preferred pyrethroid insecticides include tefluthrin and lambda cyhalothrin. Mixtures of pyrethroid insecticides are also contemplated.

Phosphorus insecticides useful in the compositions include, without limitation, phorate, phosalone, phosmet, phosphamidon, phoxim. Mixtures of phosphorus insecticides are also contemplated.

Carbamate insecticides useful in the compositions include, without limitation, pirimicarb, benfuracarb, carbaryl, carbofuran, carbosulfan, ethiofencarb, fenobucarb, formetanate, furathiocarb, isoprocarb, methiocarb, methomyl, metolcarb, oxamyl, propoxur, trimethacarb, 3,5-xylyl methylcarbamate, and xylylcarb. Mixtures of carbamate insecticides are also contemplated.

Mixtures of the classes of insecticides are also contemplated. For example, and not for limititation, carbamate insecticides may be mixed with pyrethroid, neonicotinoid, or phosphorus insecticides; pyrethroid insecticides may be mixed with carbamate, neonicotinoid, or phosphorus insecticides; neonicotinoid insecticides may be mixed with pyrethroid, phosphorus or carbamate insecticides; phosphorus insecticides may be mixed with neonicotinoid, carbamate, or pyrethroid insecticides.

In one embodiment, the composition includes about 0.75% w/w fludioxonil, about 0.75% w/w picarbutrazox, about 1% w/w mefenoxam, about 1.5% w/w sedaxane, and about 4.25% w/w thiabendazole. In a more specific embodiment, the composition includes 0.72% w/w fludioxonil, 0.72% w/w picarbutrazox, 1.07% w/w mefenoxam, 1.43% w/w sedaxane, and 4.3% w/w thiabendazole.

In one embodiment, the composition includes about 1% w/w fludioxonil, about 17% w/w thiamethoxam, about 2.5% w/w mefenoxam, about 1% w/w sedaxane, about 2% w/w thiabendazole, and about 0.5% w/w picarbutrazox. In a more specific embodiment, the composition includes 0.85% w/w fludioxonil, 17% w/w thiamethoxam, 2.56% w/w mefenoxam, 0.85% w/w sedaxane, 1.7% w/w thiabendazole, and 0.34% w/w picarbutrazox

In one embodiment, the composition includes about 10% w/w tymirium, about 4% w/w fludioxonil, about 5% w/w difenoconazole, and about 4% w/w metalaxyl-M. In a more specific embodiment, the composition includes 10.43% w/w tymirium, 4.35% w/w fludioxonil, 5.35% w/w difenoconazole, and 4.35% w/w metalaxyl-M.

### Application Rates

The compositions can be applied to seeds on an application rate based on volume per weight of seeds. In certain embodiments, the application rate is 100-2500 ml/100 kg or in other embodiments 10-750 ml/100 kg of seed. In other embodiments, the application rate is about 100-500 ml/100 kg of seed.

### Plant Propagation Material

Plant propagation material includes seeds and cuttings and other generative parts of plants including tubers (such as but not limited to potatoes, Jerusalam artichokes and yams), bulbs (such as but not limited to onion, hyacinth, squill, amaryllis, snowdrop, tulip, daffodil, narcissis, lily and orchid), root vegetables (such as but not limited to carrots, beets, arrowhead, arrowroot, cassayas, Chinese artichoke, globe artichoke, horseradish, parsnips, radishes, and the like), trees, shrubs, and other ornamentals, including roses.

### Surface Active Agent

The compositions can contain at least about 2% up to about 10% w/w of a surface-active agent. In one embodiment, the aqueous compositions contain from 3% up to about 7% w/w of a surface-active agent.

The surface active agent (a) comprises (a1) at least one anionic surfactant. In general, the anionic surfactant may be any known in the art. Suitable anionic surfactants are in general oligomers and polymers, as well as polycondensates, which contain a sufficient number of anionic groups to ensure their water-solubility. Suitable anionic surfactants include alcohol sulfates, alcohol ether sulfates, alkylaryl ether sulfates, alkylaryl sulfonates such as alkylbenzene sulfonates and alkylnaphthalene sulfonates and salts thereof, alkyl sulfonates, mono- or di-phosphate esters of polyalkoxylated alkyl alcohols or alkylphenols, mono- or di-sulfosuccinate esters of C12-C15 alkanols or polyalkoxylated C12-C15 alkanols, alcohol ether carboxylates, phenolic ether carboxylates, polybasic acid esters of ethoxylated polyoxyalkylene glycols consisting of oxybutylene or the residue of tetrahydrofuran, sulfoalkylamides and salts thereof such as N-methyl-M-oleoyltaurate Na salt, polyoxyalkylene alkylphenol carboxylates, polyoxyalkylene alcohol carboxylates alkyl polyglycoside/alkenyl succinic anhydride condensation products, alkyl ester sulfates, napthalene sulfonates, naphthalene formaldehyde condensates, alkyl sulfonamides, sulfonated aliphatic polyesters, sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts, salts of ligninsulfonic acid such as the sodium, potassium, magnesium, calcium or ammonium salt, polyarylphenol polyalkoxyether sulfates and polyarylphenol polyalkoxyether phosphates, and sulfated alkyl phenol ethoxylates and phosphated alkyl phenol ethoxylates.

Specific examples of suitable anionic surfactants include: Geropon T77 (Rhodia) (N-methyl-N-oleoyltaurate Na salt); Soprophor 4D384 (Rhodia) (tristyrylphenol sulphate); Reax 825 (Westvaco) (ethoxylated lignin sulfonate); Stepfac 8171 (Stepan) (ethoxylated nonylphenol phosphate ester); Ninate 401-A (Stepan) (calcium alkylbenzene sulfonate); Emphos CS-131 (Witco) (ethoxylated nonylphenol phosphate ester); and Atphos 3226 (Unigema) (ethoxylated tridecylalcohol phosphate ester). Suitable anionic surfactants can be prepared by methods known per se and also are commercially available.

The surface-active agent comprising a1) at least one anionic surfactant may optionally further comprise a2) one or more nonionic surfactants. As used herein, “nonionic surfactants” are different compounds from the water-dispersible and water-soluble polymers b) described herein.

Exemplary nonionic surfactants include polyarylphenol polyethoxy ethers, polyalkylphenol polyethoxy ethers, polyglycol ether derivatives of saturated fatty acids, polyglycol ether derivatives of unsaturated fatty acids, polyglycol ether derivatives of aliphatic alcohols, polyglycol ether derivatives of cycloaliphatic alcohols, fatty acid esters of polyoxyethylene sorbitan, alkoxylated vegetable oils, alkoxylated acetylenic diols, polyalkoxylated alkylphenols, fatty acid alkoxylates, sorbitan alkoxylates, sorbitol esters, C8-C22 alkyl or alkenyl polyglycosides, polyalkoxy styrylaryl ethers, alkylamine oxides, block copolymer ethers, polyalkoxylated fatty glyceride, polyalkylene glycol ethers, linear aliphatic or aromatic polyesters, organo silicones, polyaryl phenols, sorbitol ester alkoxylates, and mono- and diesters of ethylene glycol and mixtures thereof.

Specific examples of suitable nonionic surfactants include: Genapol X-060 (Clariant) (ethoxylated fatty alcohol); Sorpohor BSU (Rhodia) ethoxylated tristyrylphenol; Makon TD-6 (Stepan) (ethoxylated fatty alcohol); BRIJ 30 (Unigema) (ethoxylated lauryl alcohol); Witconol CO-360 (Witco) (ethoxylated castor oil); and Witconol NP-60 (Witco) (ethoxylated nonylphenol). Suitable nonionic surfactants can be prepared by methods known per se and also are commercially available.

In addition to anionic and nonionic surfactants, certain cationic or zwitterionic surfactants a3) also are suitable for use in the present invention such as alkanol amides of C8-C18 fatty acids and C8-C18 fatty amine polyalkoxylates, C10-C18 alkyldimethylbenzylammonium chlorides, coconut alkyldimethylaminoacetic acids, and phosphate esters of C8-C18 fatty amine polyalkoxylates.

In one embodiment, a mixture of surfactants (a1), (a2) and optionally (a3) is employed as follows:
(1) 0.5-4% w/w of a wetting agent selected from (a1) at least one anionic surfactant. Suitable anionic surfactant wetting agents include sulfoalkylamides and salts thereof such as N-methyl-N-oleoyltaurate Na salt, alkylaryl sulfonates such as alkylbenzene sulfonates and alkylnaphthalene sulfonates and salts thereof and salts of ligninsulfonic acid;
(2) 1-4% w/w of a dispersing agent selected from (a1) at least one anionic surfactant. Suitable anionic surfactant dispersing agents include sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts;
(3) 1 to 5% w/w of an emulsifying agent selected from (a1) at least one anionic surfactant, (a2) at least one nonionic surfactant and a mixture thereof. Suitable anionic/nonionic surfactant emulsifiers include salts of ethoxylated alkylphenols, polyoxyethylene-polyoxypropylene alkylphenols, (fatty) alcohol ethoxylates and ethoxylated tristyrylphenols.

### Film-Forming Polymer

The composition can also include at least one polymer selected from water-soluble and water-dispersible polymers. Suitable polymers have an average molecular weight of at least about 1,000 up to about 100,000; more specifically at least about 5,000, up to about 100,000. The aqueous compositions generally contain from about 0.5% to about 10% w/w of polymer (b). In a specific embodiment, the compositions contain from about 1.0% up to about 5% w/w of a polymer.

Suitable polymers are selected from:
b1) alkyleneoxide random and block copolymers such as ethylene oxide-propylene oxide block copolymers (EO/PO block copolymers) including both EO-PO-EO and PO-EO-PO block copolymers;
ethylene oxide-butylene oxide random and block copolymers,
C2-6 alkyl adducts of ethylene oxide-propylene oxide random and block copolymers,
C2-6 alkyl adducts of ethylene oxide-butylene oxide random and block copolymers,
b2) polyoxyethylene-polyoxypropylene monoalkylethers such as methyl ether, ethyl ether, propyl ether, butyl ether or mixtures thereof.
b3) vinylacetate/vinylpyrrolidone copolymers,
b4) alkylated vinylpyrrolidone copolymers,
b5) polyvinylpyrrolidone, and
b6) polyalkyleneglycol including the polypropylene glycols and polyethylene glycols.

Specific examples of suitable polymers include Pluronic P103 (BASF) (EO-PO-EO block copolymer), Pluronic P65 (BASF) (EO-PO-EO block copolymer), Pluronic P108 (BASF) (EO-PO-EO block copolymer), Vinamul 18160 (National Starch) (polyvinylacetate), Agrimer 30 (ISP) (polyvinylpyrrolidone), Agrimer VA7w (ISP) (vinyl acetate/vinylpyrrolidone copolymer), Agrimer AL 10 (ISP) (alkylated vinylpyrrolidone copolymer), PEG 400 (Unigema) (polyethylene glycol), Pluronic R 25R2 (BASF) (PO-EO-PO block copolymer), Pluronic R 31R1 (BASF) (PO-EO-PO block copolymer) and Witconol NS 500LQ (Witco) (butanol PO-EO copolymer).

### Carrier

The composition can also comprise, at least about 1 and up to about 20% w/w, more specifically from 5 to about 15% w/w of at least one solid carrier.

The solid carrier is a natural or synthetic solid material that is insoluble in water. This carrier is generally inert and acceptable in agriculture, especially on the treated seed or other propagation material. It can be chosen, for example, from clay, diatomaceous earth, natural or synthetic silicates, titanium dioxide, magnesium silicate, aluminum silicate, talc, pyrophyllite clay, silica, attapulgite clay, kieselguhr, chalk, limestone, calcium carbonate, bentonite clay, Fuller's earth, and the like.

### Antifreeze

The composition can comprise, at least about 3 and up to about 25% w/w of at least one antifreeze agent, more specifically from 6 to about 20% w/w.

Specific examples of suitable antifreezes include ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, octaglycerol and the like.

As a particular subset of suitable antifreeze materials there can be mentioned ethylene glycol, propylene glycol and glycerin.

### Additional Components

The composition optionally contains at least one thickener.

In one embodiment, the thickener is present in the aqueous composition in an amount from about 0.01% to about 25% w/w, more specifically from 0.02 to 10% w/w.

Illustrative of thickeners (water-soluble polymers which exhibit pseudoplastic properties in an aqueous medium) are gum arabic, gum karaya, gum tragacanth, guar gum, locust bean gum, xanthan gum, carrageenan, alginate salt, casein, dextran, pectin, agar, 2-hydroxyethyl, starch, 2-aminoethyl starch, 2-hydroxyethyl cellulose, methyl cellulose, carboxymethyl cellulose salt, cellulose sulfate salt, polyacrylamide, alkali metal salts of the maleic anhydride copolymers, alkali metal salts of poly(meth)acrylate, and the like.

As suitable thickeners there may also be mentioned attapulgite-type clay, carrageenan, croscarmellose sodium, furcelleran, glycerol, hydroxypropyl methylcellulose, polystyrene, vinylpyrrolidone/styrene block copolymer, hydroxypropyl cellulose, hydroxypropyl guar gum, and sodium carboxymethylcellulose. Xanthan gum is preferred.

The aqueous composition according to the invention can be employed together with the adjuvants customary in formulation technology, biocides, biostats, emulsifiers (lethicin, sorbitan, and the like), antifoam agents or application-promoting adjuvants customarily employed in the art of formulation. In addition, there may be mentioned inoculants and brighteners.

Additionally, a coloring agent, such as a dye or pigment is included in the seed coating so that an observer can immediately determine that the seeds are treated. The dye is also useful to indicate to the user the degree of uniformity of the coating applied.

The inventive compositions contain and/or may be applied together or sequentially with further active compounds. These further compounds can be fertilizers or micronutrient donors or other preparations that influence plant growth. They can also be selective herbicides, insecticides, fungicides, bactericides, insect growth regulators, plant growth regulators, nematicides, molluscicides or mixtures of several of these preparations.

### Process

The compositions can be prepared by processes known in the art.

In one embodiment, the aqueous fungicidal compositions of the invention can be prepared by a process which comprises the steps: (a) forming a premix with at least one fungicidally active compound and at least one surfactant; (b) forming a premix of a carrier and water, and (c) sequentially adding the premixes (a) and (b) and the remaining ingredients to water while stirring to form a homogeneous composition.

In some embodiments, the process comprises: (a) preparing a concentrate and (b) diluting the concentrate with water or other diluent to reach desired concentration.

### Compositions

Compositions may take the form of aqueous solutions, dispersions, suspensions, emulsions or suspoemulsions. In one embodiment, the composition is a ready for use suspoemulsion.

The average size of the suspended particles is 0.1 to 20, specifically 1.5 to 5 microns when measured with a laser particle analyzer, e.g a CILAS 920 apparatus.

The viscosity of the aqueous composition is 50 to 2000, more specifically 100 to 1000 mPas when measured with a BROOKFIELD viscometer with spindle 3 at 30 rpm and 25° C.

The aqueous compositions according to the invention are stable and maintain their viscosity and homogeneity for at least 12 months at 25° C.

### Use

For the purposes herein, seed treatments are defined as chemical or biological substances that are applied to seeds or vegetative plant propagation materials to control disease organisms, insects, or other pests. The seed treatment composition of the invention includes fungicides, but can also include other pesticides such as bactericides and insecticides. In a preferred embodiment according to the present invention, the composition can be a seed treatment composition which can comprise fludioxonil, mefenoxam, castor oil, and optionally at least one agrochemical, preferably at least two agrochemicals, and more preferably all the agrochemicals, selected from picarbutrazox, sedaxane, and thiabendazole. Most seed treatments are applied to true seeds, which have a seed coat surrounding an embryo. However, some seed treatments can be applied to vegetative plant propagation materials such as rhizomes, bulbs, corms or tubers.

The compositions can be formulated for protecting cultivated plants and their propagation materials. The compositions are advantageously formulated for seed treatment applications against diseases in the soil, which mostly occur in the early stages of plant development. For example, the compositions can be formulated to target pathogens including Pythium, Tilletia, Gerlachia, Septoria, Ustilago, Fusarium, Rhizoctonia (so-called “damping off complex”); Oomycetes such as Phytophthora, Plasmopara, Pseudoperonospora, Bremia etc. as well as against the Botrytis species, Pyrenophora, Monilinia and further representatives of the Ascomycetes, Deuteromycetes and Basidiomycetes classes.

Suitable target crops are especially potatoes, cereals (wheat, barley, rye, oats, rice), maize, sugar beet, cotton, millet varieties such as sorghum, sun flowers, beans, peas, oil plants such as canola, rape, soybeans, cabbages, tomatoes, eggplants (aubergines), pepper and other vegetables and spices as well as ornamental shrubs and flowers.

Suitable target crops also include transgenic crop plants of the foregoing varieties. The transgenic crop plants used according to the invention are plants, or propagation material thereof, which are transformed by means of recombinant DNA technology in such a way that they are—for instance—capable of synthesizing selectively acting toxins as are known, for example, from toxin-producing invertebrates, especially of the phylum Arthropoda, as can be obtained from Bacillus thuringiensis strains; or as are known from plants, such as lectins; or in the alternative capable of expressing a herbicidal or fungicidal resistance. Examples of such toxins, or transgenic plants which are capable of synthesizing such toxins, have been disclosed, for example, in EP-A-0 374 753, WO 93/07278, WO 95/34656, EP-A-0 427 529 and EP-A-451 878 and are incorporated by reference in the present application.

The inventive compositions are particularly suited for dressing applications on plant propagation material. The latter term embraces seeds of all kinds (fruit, tubers, grains), cuttings, cut shoots and the like. The preferred field of application is the treatment of all kinds of seeds (as specified in the target crops above), and in particular the seed treatment of canola, maize, cereals, soybeans and other legumes and crops that are susceptible.

The techniques of seed treatment application are well known to those skilled in the art, and they may be used readily in the context of the present invention. The compositions of the invention is applied to the seed as slurry or a soak. There also may be mentioned, e.g., film coating or encapsulation. The coating processes are well known in the art, and employ, for seeds, the techniques of film coating or encapsulation, or for the other multiplication products, the techniques of immersion. The method of application of the compositions to the seed may be varied and the invention is intended to include any technique that is to be used.

One method of applying the composition according to the invention consists in spraying or wetting the plant propagation material with the aqueous liquid preparation, or mixing the plant material with such liquid preparation. Also, before the application, the composition of the invention may be diluted with water by simple mixing at ambient temperature in order to prepare an on-farm seed treatment formulation.

In one embodiment a concentrate or dilute composition of the invention is applied to seed by spraying, wetting or mixing in a volume of from 200 ml to 3 liters of aqueous composition per 100 kg of seed, more specifically, from 400 ml to 2 liters of aqueous composition per 100 kg of seed.

As noted above, the compositions of this invention may be formulated or mixed in the seed treater tank or combined on the seed by overcoating with other seed treating agents. The agents to be mixed with the compounds of this invention may be for the control of pests, nutrition, and the control of plant diseases.

### EXAMPLES

The following examples illustrate some further aspects of the invention but are not intended to limit its scope. Where not otherwise specified throughout this specification and claims, percentages are w/w.

### Example 1: Solubility of Fludioxonil in Various Vegetable Oils

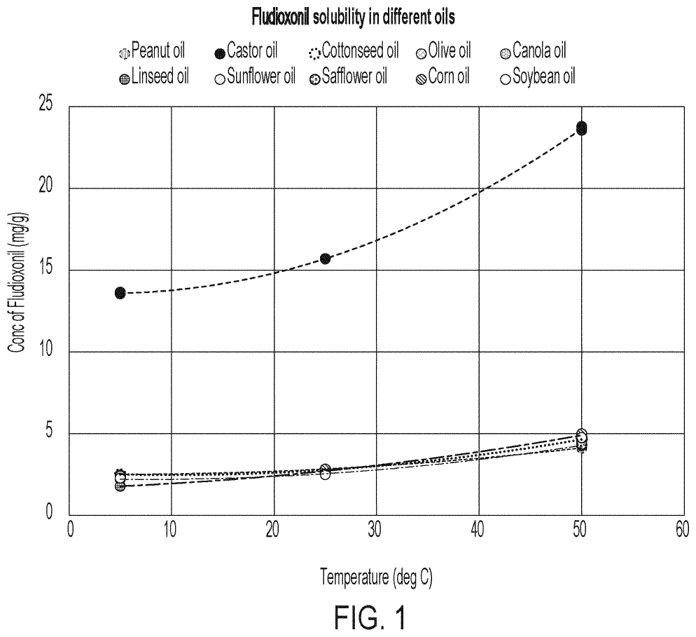

0.5 g of fludioxonil technical was mixed separately with 5 g of various oils (peanut oil, castor oil, cottonseed oil, olive oil, canola oil, linseed oil, sunflower oil, safflower oil, corn oil, and soybean oil) and incubated at 3 different temperatures (5C, 25C and 50C). The mixtures were then centrifuged and the clear oil supernatant was recovered and analyzed for fludioxonil content. Of all the vegetable oils tested, castor oil stood out as having significantly improved solubility for fludioxonil whereas all other oils had essentially the same solubilities for fludioxonil. The results of the Experiment as presented in FIG. 1.

### Example 2: Solubility of Fludioxonil in a Suspo-Emulsion Formulation Containing Variable Concentrations of Mefenoxam and Castor Oil or Soybean Oil

Formulation blanks were designed with the components described in Table 1. The components denoted as “varied” were added to the formulation blank by w/w % as per the compositions specified in Tables 2 and 3. The A-series blanks generated were made with castor oil and the B-series blanks were made with soybean oil.

TABLE 1

| | % |
|---|---|
| Blank | component |
| SOPROPHOR BSU | 1.71 |
| ATLOX METASPERSE 100 L | 1 |
| Castor Oil or soybean oil | Varied |
| SOPROPHOR 3 D 33 | 0.48 |
| TOXIMUL 8320 | 4.06 |
| 1,2-PROPYLENE GLYCOL | 7.21 |
| Pluronic P103 (from pigment dispersion) | 0.90 |
| Mefenoxam | Varied |
| POTABLE WATER | Varied |

TABLE 2a

| | A-1 | A-2 | A-3 | A-4 | A-5 | A-6 |
|---|---|---|---|---|---|---|
| Blank unvaried | 15.36 | 15.36 | 15.36 | 15.36 | 15.36 | 15.36 |
| components | | | | | | |
| MFX | 2 | 5 | 10 | 15 | 2 | 5 |
| Castor Oil | 5 | 13 | 20 | 5 | 13 | 20 |
| Water | 59.64 | 48.64 | 36.64 | 46.64 | 51.64 | 41.64 |
| Total (without Ais) | 82 | 82 | 82 | 82 | 82 | 82 |

TABLE 2b

| | A-7 | A-8 | A-9 | A-10 | A-11 | A-12 |
|---|---|---|---|---|---|---|
| Blank unvaried | 15.36 | 15.36 | 15.36 | 15.36 | 15.36 | 15.36 |
| components | | | | | | |
| MFX | 10 | 15 | 2 | 5 | 10 | 15 |
| Castor Oil | 5 | 13 | 20 | 5 | 13 | 20 |
| Water | 51.64 | 38.64 | 44.64 | 56.64 | 43.64 | 31.64 |
| Total (without Ais) | 82 | 82 | 82 | 82 | 82 | 82 |

TABLE 3a

| | B-1 | B-2 | B-3 | B-4 | B-5 | B-6 |
|---|---|---|---|---|---|---|
| Blank unvaried | 15.36 | 15.36 | 15.36 | 15.36 | 15.36 | 15.36 |
| components | | | | | | |
| MFX | 2 | 5 | 10 | 15 | 2 | 5 |
| Soybean Oil | 5 | 13 | 20 | 5 | 13 | 20 |
| Water | 59.64 | 48.64 | 36.64 | 46.64 | 51.64 | 41.64 |
| Total (without Ais) | 82 | 82 | 82 | 82 | 82 | 82 |

TABLE 3b

| | B-7 | B-8 | B-9 | B-10 | B-11 | B-12 |
|---|---|---|---|---|---|---|
| Blank unvaried | 15.36 | 15.36 | 15.36 | 15.36 | 15.36 | 15.36 |
| components | | | | | | |
| MFX | 10 | 15 | 2 | 5 | 10 | 15 |
| Soybean Oil | 5 | 13 | 20 | 5 | 13 | 20 |
| Water | 51.64 | 38.64 | 44.64 | 56.64 | 43.64 | 31.64 |
| Total (without Ais) | 82 | 82 | 82 | 82 | 82 | 82 |

The following matrices of blank compositions were analyzed for their propensity to solubilize fludioxonil. The matrices were generated by varying mefenoxam and oil loadings (castor or soybean) in the formulation.

### Matrix A

| | MFX Loading in | | | |
|---|---|---|---|---|
| Blank A | Blank (non-normalized) | | | |
| Castor Oil | 2.00 | 5.00 | 10.00 | 15.00 |
| loading in blank | | | | |
| (non-normalized) | | | | |
| 5.00 | A-1 | A-2 | A-3 | A-4 |
| 13.00 | A-5 | A-6 | A-7 | A-8 |
| 20.00 | A-9 | A-10 | A-11 | A-12 |

### Matrix B

| | MFX Loading in | | | |
|---|---|---|---|---|
| Blank B | Blank (non-normalized) | | | |
| Soybean Oil loading | 2.00 | 5.00 | 10.00 | 15.00 |
| in blank (non- | | | | |
| normalized) | | | | |
| 5.00 | B-1 | B-2 | B-3 | B-4 |
| 13.00 | B-5 | B-6 | B-7 | B-8 |
| 20.00 | B-9 | B-10 | B-11 | B-12 |

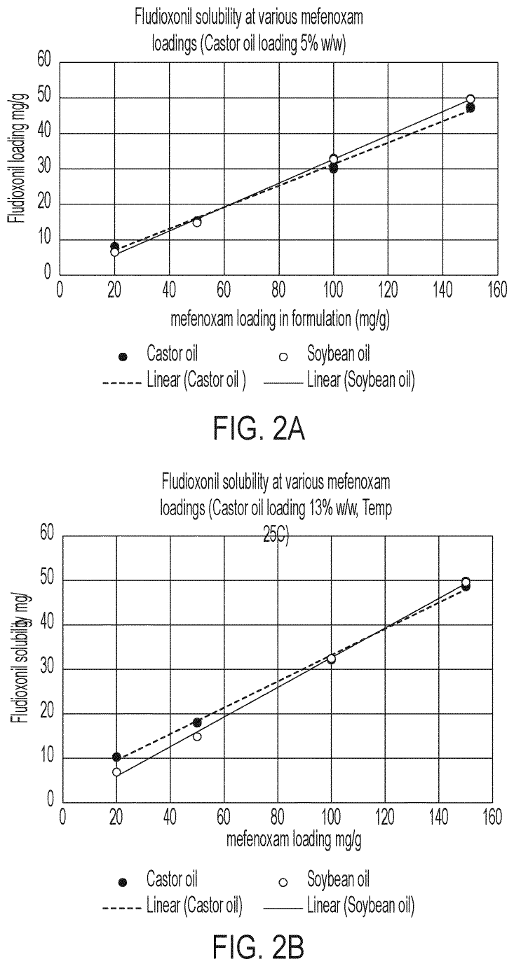

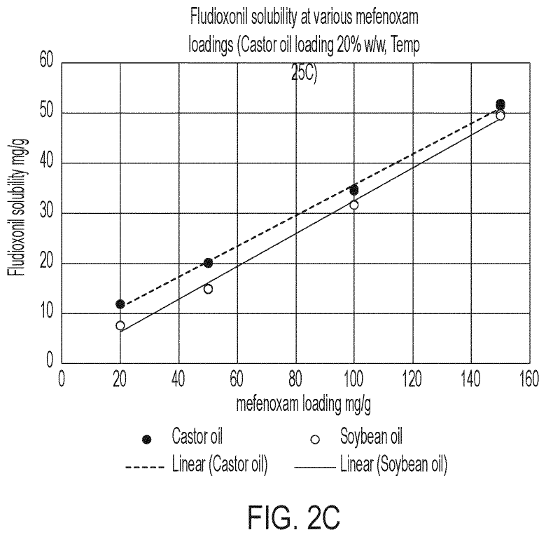

0.5 g of fludioxonil and 0.5 g of sedaxane was added to 5 g of each formulation blank and incubated for 2 weeks at room temperature. The blank mixtures were then centrifuged and the supernatants were recovered and analyzed for fludioxonil and sedaxane content. The plots in FIGS. 2A-2C illustrate the solubilities of fludioxonil and sedaxane as mefenoxam and castor oil or soybean oil content is varied.

Based on the above studies, the loadings of fludioxonil allowed by the formulation blanks are as follows, where fludioxonil will be fully solubilized at room temperature.

| | | | | | | % improved |
|---|---|---|---|---|---|---|
| | FDL loading | | FDL loading | | | FDL |
| Blanks | allowed where | Blanks | allowed where | | | loading in |
| with | FDL is fully | with | FDL is fully | MFX | Oil | castor oil vs. |
| Castor | solubilized | Soybean | solubilized | loading | loading | soybean oil |
| Oil | (mg/g) | Oil | (mg/g) | (mg/g) | (mg/g) | blanks |
| A-1 | 8.2 | B-1 | 6.5 | 20 | 50 | 26.2 |
| A-2 | 15.3 | B-2 | 14.9 | 50 | 50 | 2.68 |
| A-3 | 30.6 | B-3 | 33 | 100 | 50 | −7.27 |
| A-4 | 47.5 | B-4 | 49.8 | 150 | 50 | −4.62 |
| A-5 | 10.3 | B-5 | 6.9 | 20 | 130 | 49.3 |
| A-6 | 18.1 | B-6 | 14.8 | 50 | 130 | 22.3 |
| A-7 | 32.1 | B-7 | 32.4 | 100 | 130 | −0.93 |
| A-8 | 48.9 | B-8 | 49.9 | 150 | 130 | −2.00 |
| A-9 | 11.9 | B-9 | 7.63 | 20 | 200 | 56.0 |
| A-10 | 20.2 | B-10 | 15.1 | 50 | 200 | 33.8 |
| A-11 | 34.8 | B-11 | 31.8 | 100 | 200 | 9.43 |
| A-12 | 51.9 | B-12 | 49.8 | 150 | 200 | 4.22 |

As can be seen, in most combinations of mefenoxam and oil loadings explored in these matrices, castor oil demonstrates an improved solubility for fludioxonil at room temperature, thus allowing for higher loaded fludioxonil formulation without risk of crystallization upon temperature cycling.

### Example 3: Crystallization Study of Formulation Containing Fludioxonil

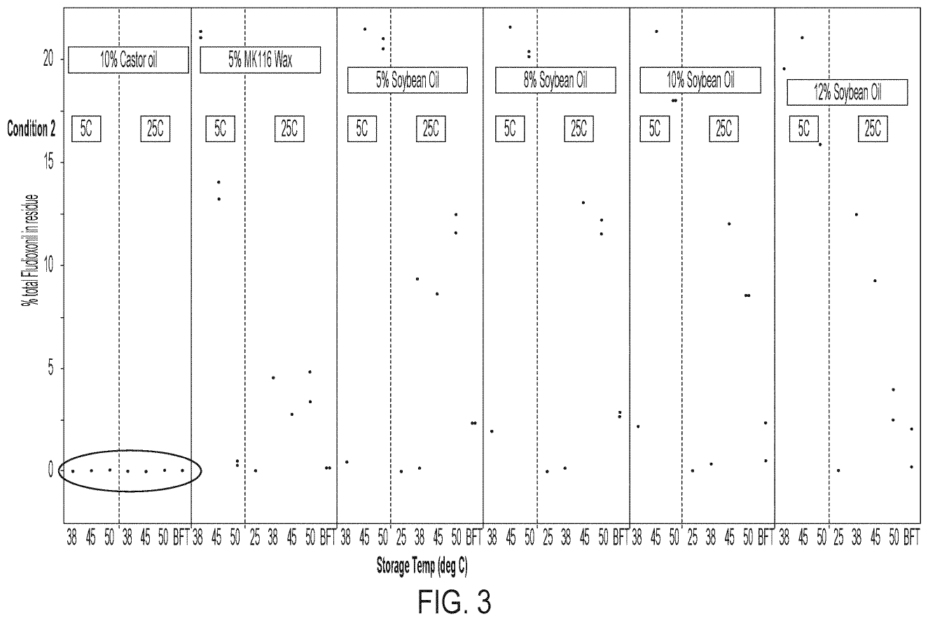

A formulation containing 0.72% w/w fludioxonil, 0.72% w/w picarbutrazox, 1.43% w/w sedaxane, 4.30% w/w thiabendazole and 1.07% w/w mefenoxam was prepared with castor oil or MK 116 Wax or soybean oil as the flow aid. Castor oil loading was maintained at 10% w/w. MK 116 wax loading was maintained at 5% w/w, whereas soybean oil concentration was varied over a range of 5-12% w/w. The formulation was aliquoted into 50 g samples and placed at temperatures of 50° C., 45° C. 38° C., a freeze thaw cycle going from 50° C. to −10° C. and at 25° C. These formulations were stored for 2 weeks at the indicated conditions (Condition 1), after which they were removed and placed at 25° C. or 5° C. for 2 weeks (Condition 2). After completion of the storage regime, the formulations were diluted with 200 mL of water and poured through a 325 mesh sieve. The residue was collected and analysed for the presence of fludioxonil. The fludioxonil content of the residue was determined in terms of wt % and plotted as shown in FIG. 3. As illustrated by FIG. 3, while soybean oil and MHK116 Wax resulted in loss of fludioxonil, castor oil surprisingly did not.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

1. A composition, comprising:
fludioxonil, and
castor oil.

2. The composition according to claim 1, wherein the composition is formulated as a seed treatment.

3. The composition according to claim 1, wherein the fludioxonil does not crystalize when the composition is exposed to temperatures between 38° C. and 50° C. followed by room temperature to 5° C. storage.

4. The composition according to claim 1, wherein fludioxonil is present in about 0.1 to 5% w/w.

5. The composition according to claim 1, wherein fludioxonil is present in about 0.1 to 1% w/w.

6. The composition according to claim 1, wherein castor oil is present in about 0.1 to 25% w/w.

7. The composition according to claim 1, wherein castor oil is present in about 2 to 15% w/w.

8. The composition according to claim 1, further comprising mefenoxam.

9. The composition according to claim 8, wherein mefenoxam is present in about 0.1 to 3% w/w.

10. The composition according to claim 1, wherein the composition comprises an organic phase and the ratio of organic phase to castor oil is greater than about 1:1.

11. The composition according to claim 1, wherein the composition comprises an organic phase and the ratio of organic phase to castor oil is greater than about 1:10.

12. The composition according to claim 8, wherein mefenoxam is present in about 1% w/w.

13. The composition according to claim 1, wherein the fludioxonil does not crystalize when the composition is exposed to 50° C. followed by 5° C. storage.

14. The composition according to claim 1, wherein the composition further comprises at least four additional agrochemicals.

15. A method of controlling fungi, comprising applying a composition according to claim 1, to a seed.

16. A seed treatment composition, comprising:
fludioxonil,
mefenoxam,
castor oil, and
optionally at least one agrochemical, preferably at least two agrochemicals, and more preferably all the agrochemicals, selected from picarbutrazox, sedaxane, and thiabendazole.

17. A method of reducing the crystallization of fludioxonil, comprising adding castor oil to a composition comprising fludioxonil.
